(19) United States
(12) Patent Application Publication
(10) Pub. No.: US 2008/0248879 A1
(43) Pub. Date: Oct. 9, 2008

(54) Gaming Device Firewall

(75) Inventor: Jason A. Smith, Vernon Hills, IL (US)

Correspondence Address: SCHWEGMAN, LUNDBERG & WOESSNER/WMS GAMING, P.O. BOX 2938, MINNEAPOLIS, MN, 55402, US

(73) Assignee: WMS Gaming Inc., Waukegan, IL (US)

(21) Appl. No.: 12/089,455

(22) PCT Filed: Oct. 10, 2006
(86) PCT No.: PCT/US06/39452

§ 371 Date: Apr. 7, 2008

Related U.S. Application Data
(60) Provisional application No. 60/725,941, filed on Oct. 12, 2005.

(51) Int. Cl. A63F 9/24; G06F 9/00

(52) U.S. Cl. 463/42; 726/11

(57) ABSTRACT

Methods and apparatus for gaming device software firewall are described herein. In one embodiment, a gaming device can include a network interface card operable to receive a plurality of gaming network communication packets from a gaming network. The gaming device can also include a gaming device firewall operable to apply a set of firewall rules to the plurality of gaming network communication packets and to drop some of the gaming network communication packets based on the set of firewall rules. The gaming device can also include set of gaming device applications operable to receive some of the gaming network communication packets.

### CROSS REFERENCE TO RELATED APPLICATIONS

This application also claims priority to U.S. Provisional Patent application No. 60/700,939 filed Jul. 20, 2005, which is hereby incorporated by reference.

### LIMITED COPYRIGHT WAIVER

A portion of the disclosure of this patent document contains material to which the claim of copyright protection is made. The copyright owner has no objection to the facsimile reproduction by any person of the patent document or the patent disclosure, as it appears in the U.S. Patent and Trademark Office file or records, but reserves all other rights whatsoever. Copyright 2005, WMS Gaming, Inc.

### FIELD

This invention relates generally to the field of wagering game machines and more particularly to the field of processing gaming machine information received over gaming networks.

### BACKGROUND

A wide variety of computerized wagering game machines (a.k.a. gaming machines) are now available to casino operators and players. Computerized gaming machines range from slot machines to games that are traditionally played live, such as poker, blackjack, roulette, etc. These computerized gaming machines provide many benefits to game owners and players, including increased reliability over mechanical machines, greater game variety, improved sound and animation, and lower overall management cost.

In some jurisdictions, gaming regulators have recently allowed gaming machines to receive gaming content over gaming networks. However, some regulators and gaming operators are concerned that poor gaming network security could result in gaming machines receiving unapproved or maliciously modified gaming content. In order to increase gaming network security, some gaming machine operators have taken measures to physical secure gaming network cables and devices. Additionally, some gaming machine makers have bolstered gaming machine security by using digitally signed software, which enables gaming machines to determine whether software has been tampered-with and/or whether it originated from trusted sources.

Because gaming machines will be receiving gaming content via gaming networks, there is a need for new and innovative techniques for augmenting gaming network security.

### SUMMARY

Methods and apparatus for a gaming device firewall are described herein. In one embodiment, a gaming device can include a network interface card operable to receive a plurality of gaming network communication packets from a gaming network. The gaming device can also include a gaming device firewall operable to apply a set of firewall rules to the plurality of gaming network communication packets and to drop some of the gaming network communication packets based on the set of firewall rules. The gaming device can also include set of gaming device applications operable to receive some of the gaming network communication packets.

### BRIEF DESCRIPTION OF THE FIGURES

The present invention is illustrated by way of example and not limitation in the Figures of the accompanying drawings in which:

FIG. 1 is a dataflow diagram illustrating dataflow and operations associated with filtering gaming network communication packets using a gaming device firewall, according to example embodiments of the invention;

FIG. 2 is a block diagram illustrating components of a gaming machine, used in conjunction with example embodiments of the invention;

FIG. 3 is a block diagram illustrating a wagering game network, according to example embodiments of the invention;

FIG. 4 is a flow diagram illustrating operations for filtering gaming network communications with a gaming device firewall, according to example embodiments of the invention;

FIG. 5 is a flow diagram illustrating operations for filtering network traffic through network interfaces on a gaming machine, according to example embodiments of the invention;

FIG. 6 is a flow diagram illustrating operations for dynamically modifying and applying firewall rules, according to example embodiments of the invention;

FIG. 7 is a flow diagram illustrating operations for dynamically switching the firewall on/off, according to example embodiments of the invention;

FIG. 8 is a flow diagram illustrating operations for performing IP masquerading and Network Address Translation, according to example embodiments of the invention; and

FIG. 9 is a perspective view of a gaming machine, according to example embodiments of the invention.

### DESCRIPTION OF THE EMBODIMENTS

Methods and apparatus for a gaming device firewall are described herein. This description of the embodiments is divided into five sections. The first section provides an introduction to embodiments of the invention. The second section describes example gaming machine architectures and gaming networks, while the third section describes example operations performed by some embodiments of the invention. The fourth section describes example gaming machines and the fifth section provides some general comments.

### Introduction

This section introduces embodiments of a gaming device firewall. Embodiments of the gaming device firewall can filter communications received over gaming networks; thus, increasing gaming device security.

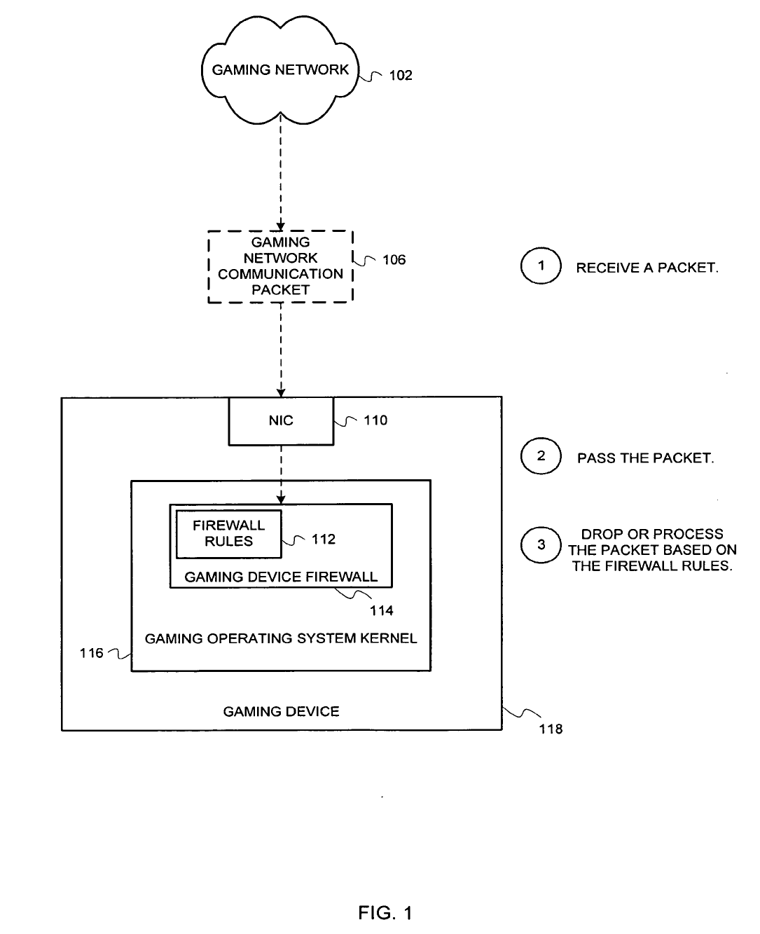

FIG. 1 is a dataflow diagram illustrating dataflow and operations associated with filtering gaming network communication packets using a gaming device firewall, according to example embodiments of the invention. As shown in FIG. 1, a gaming device 118 (e.g., gaming machine, gaming content server, etc.) can receive gaming network communication packets from a gaming network 102. The gaming device 118 includes a network interface card (NIC) 110 and a gaming operating system kernel 116. The gaming operating system kernel 116 includes a gaming device firewall 114, which includes firewall rules 112.

The dataflow and operations for filtering gaming network packets using the gaming device firewall 114 occur in three stages. During stage 1, the gaming device's NIC 110 receives a gaming network communication packet 106 from the gaming network 102. During stage two, the NIC 110 passes the gaming network communication packet 106 to the gaming device firewall 114. The gaming device firewall 114 can store the gaming network communication packet 106 in a secure memory space that is inaccessible to other gaming device components. As a result, gaming device components are not exposed to untrusted and potentially harmful data.

During stage 3, based on the firewall rules 112, the gaming device firewall 114 determines whether to drop (i.e., delete or overwrite) the gaming network communication packet 106 or to forward it for further processing. The firewall rules 112 can call for dropping gaming network communication packets for any suitable reason. For example, the firewall rules 112 can call for dropping gaming network communication packets that do not originate from specific IP or media access control (MAC) addresses. In addition, the firewall rules 112 can call for dropping packets that do not meet certain protocol specifications. For example, the firewall rules can be configured to allow only a certain number of connections in a given time period. Such firewall rules can prevent denial of service (DoS) attacks, such as “TCP SYN flood DoS” attacks.

These and other features of gaming device firewalls will be described in more detail below. The next section describes example gaming devices in more detail.

### Example Gaming Devices and Gaming Networks

This section describes example gaming devices and gaming networks with which embodiments of the invention can be practiced.

### Example Gaming Device Architecture

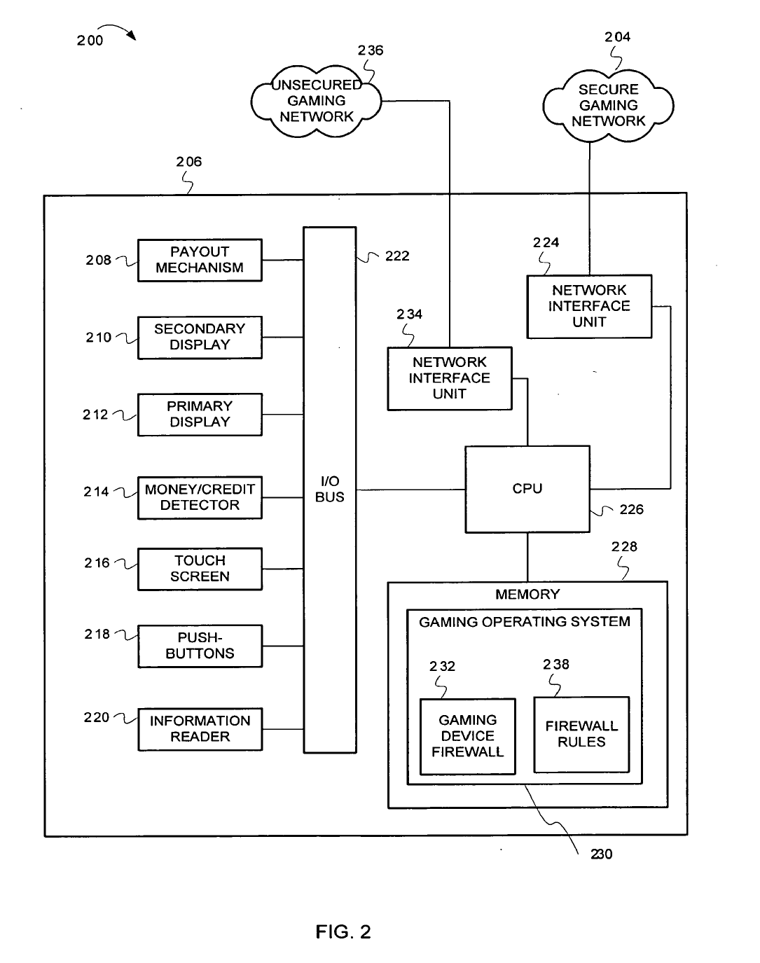

FIG. 2 is a block diagram illustrating components of a gaming machine, used in conjunction with example embodiments of the invention. As shown in FIG. 2, a gaming machine 206 includes a central processing unit (CPU) 226, which is connected to an input/output (I/O) bus 222. The I/O bus 222 is connected to payout mechanism 208, secondary display 210, primary display 212, money/credit detector 214, touchscreen 216, push-buttons 218, and information reader 220. In one embodiment, the peripheral devices can be Internet Protocol-aware devices that make-up a virtual Internet Protocol (IP) network inside the gaming machine 206. The IP-aware peripheral devices can also communicate with devices (e.g., maintenance servers) on external gaming networks. According to some embodiments, the gaming machine 206 can include additional peripheral devices and/or more than one of each component shown in FIG. 2. For example, in one embodiment, the gaming machine 206 can include multiple CPUs 226. Additionally, the components of the gaming machine 206 can be interconnected according to any suitable interconnection architecture (e.g., directly connected, hypercube, etc.).

The CPU 226 is also connected to network interface units 224 and 234. In one embodiment, network interface units 224 and 234 include Ethernet cards, telephone modems, RS-232 cards, or other suitable network interfacing logic. The network interface unit 224 is connected to a secure gaming network 204, while the network interface unit 234 is connected to an unsecured gaming network 236. According to embodiments, the secure gaming network 204 can be secured using any suitable means for physical security (e.g. by limiting access to network wires by lock and key) or using any suitable electronic security means (e.g., by encrypting network data). In one embodiment, the gaming machine 206 can include any suitable number of network interface units.

The CPU 226 is also connected to a memory unit 228. The memory unit 228 includes a gaming operating system 230, which includes a gaming device firewall 232 and firewall rules 238. According to embodiments, the gaming device firewall 232 can use the firewall rules 238 to determine whether gaming network packets should be dropped or passed-on for further processing. In one embodiment, the gaming device firewall 232 trusts gaming network packets received from the secure network 204, so it does not expend resources applying the firewall rules 238 to the trusted packets. Additionally, in one embodiment, the firewall 232 trusts packets originating from the gaming machine's IP-aware peripheral devices. The gaming operating system 230 can be a version of Linux, Unix, or Windows® adapted for use in a wagering game environment. Alternatively, the operating system 230 can be any operating system suitable for use in a gaming environment.

Any of the gaming machine's components can include machine-readable media including instructions for executing operations described herein. Furthermore, the memory unit 228 can also include tangible machine-readable media including instructions for conducting any suitable casino-style wagering game (including bonus events), such as video poker, video black jack, video slots, etc. Machine-readable media includes any mechanism that provides (i.e., stores and/or transmits) information in a form readable by a machine (e.g., a computer). For example, tangible machine-readable media includes semiconductor read only memory (ROM), semiconductor random access memory (RAM), magnetic disk storage media, optical storage media, flash memory devices, or any other suitable tangible media for providing instructions and/or data.

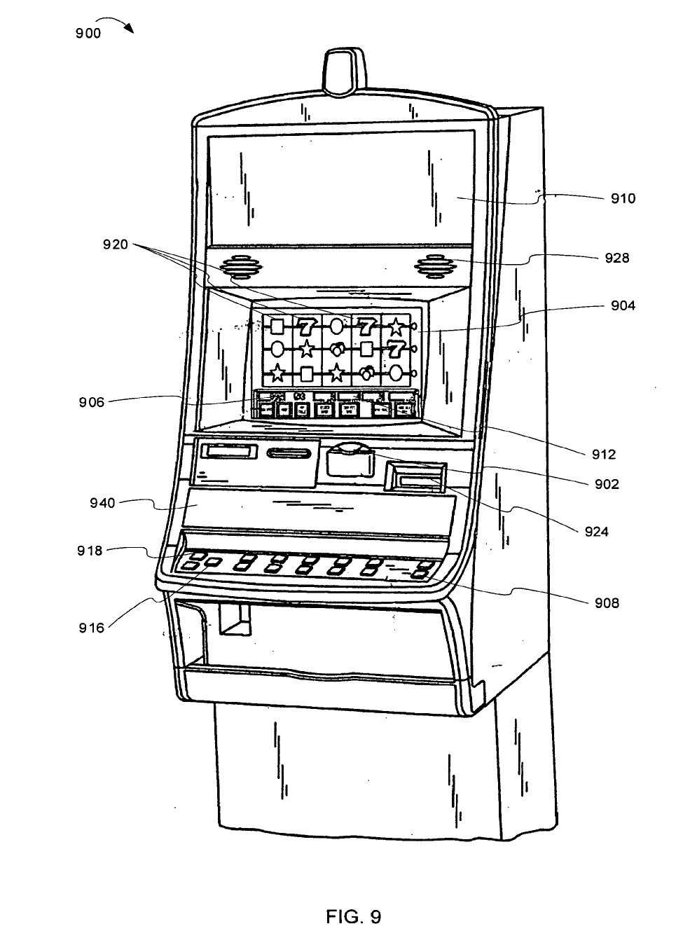

Gaming machines are described in more detail below, in the discussion of FIG. 9. This description continues with a discussion of an example gaming network.

### Example Gaming Network

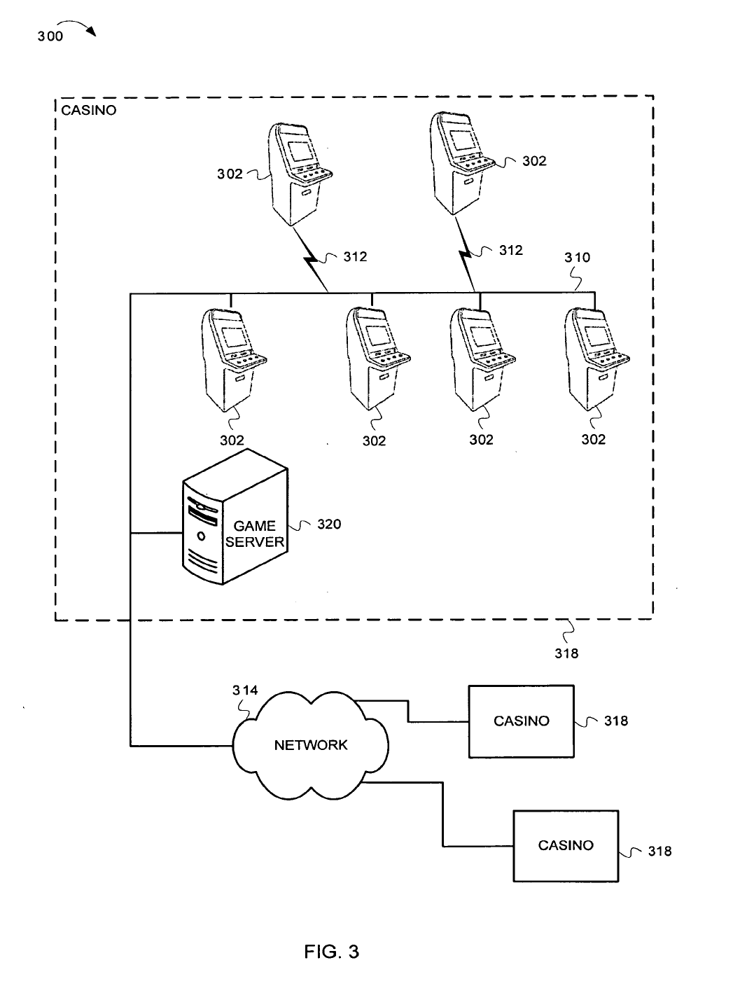

FIG. 3 is a block diagram illustrating a wagering game network, according to example embodiments of the invention. As shown in FIG. 3, the wagering game network 300 includes a plurality of casinos 318 connected to a communications network 314. Each of the plurality of casinos 318 can include a local area network, which includes a plurality of gaming machines 302 connected to a game server 320. The components of each casino 318 can communicate over wired 310 and/or wireless connections 312. Moreover, they can employ any suitable connection technology, such as Bluetooth, 802.11, Ethernet, public switched telephone networks, etc.

In one embodiment, the gaming server 320 and gaming machines 302 include tangible machine-readable media including instructions for filtering gaming network communications using a gaming device firewall. Moreover, embodiments of the gaming device firewall enable gaming machine IP-aware peripherals to communicate with devices connected to the wagering game network 300. In one embodiment, each gaming machine 302 includes two network interface units, where one of the units receives secure network traffic from inside a casino 318, while another network interface unit receives unsecured network traffic from the network 314.

Operations performed by embodiments of the invention are described in the next section.

### System Operations

This section describes operations performed by embodiments of the invention. In the discussion below, the flow diagrams will be described with reference to the block diagrams presented above. In certain embodiments, the operations are performed by instructions residing on machine-readable media (e.g., software), while in other embodiments, the operations are performed by hardware and/or other logic (e.g., digital logic). This description continues with a discussion of operations for filtering gaming network communications packets in a gaming device.

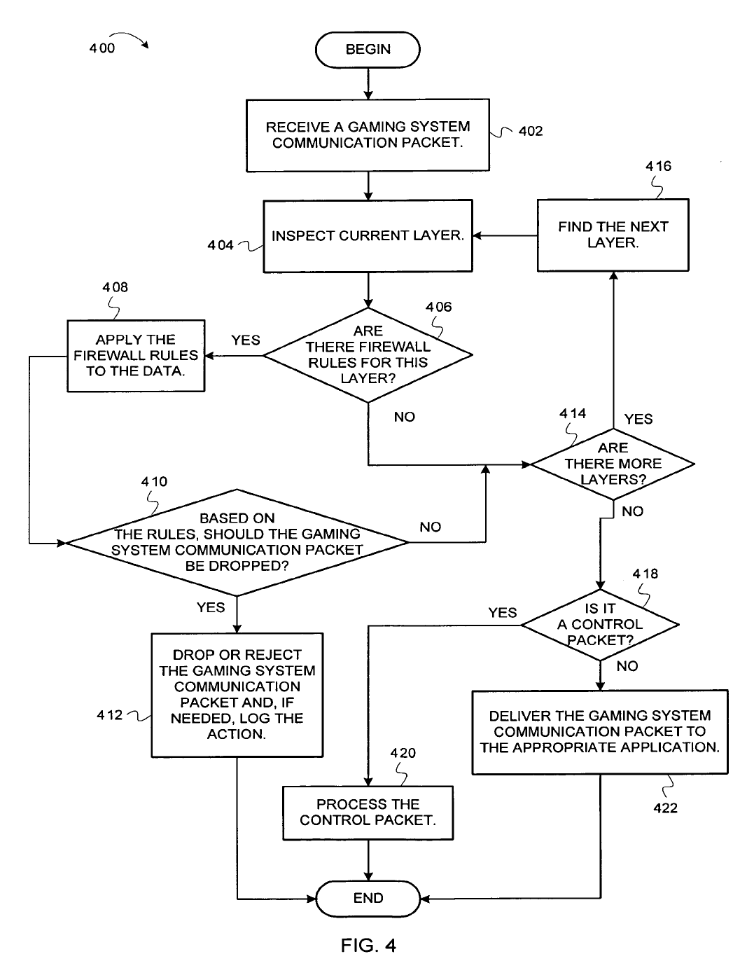

FIG. 4 is a flow diagram illustrating operations for filtering gaming network communications with a gaming device firewall, according to example embodiments of the invention. The flow diagram 400 will be described with reference to the example system shown in FIG. 2. The flow diagram 400 commences at block 402.

At block 402, a gaming network communication packet is received. For example, the gaming operating system 230 receives a gaming network communication packet through one of the network interface units 224 or 234. In one embodiment, the gaming network communication packet can be a data packet or a control packet. In one embodiment, the gaming operating system 230 delivers data packets to application programs running on the gaming device 206.

In one embodiment, control packets are network communication packets that are not delivered to an application program. Instead, control packets can be processed by a layer of the gaming operating system's communications protocol stack (not shown). For example, a “TCP Send” control packet would be processed by the TCP layer of the gaming operating system's protocol stack. The TCP layer would not deliver the TCP Send control packet to another layer in the protocol stack, nor would the gaming operating system 230 deliver the TCP Send control packet to an application program running on the gaming device 206.

The flow continues at block 404.

At block 404, a layer of the gaming network communication packet is inspected. For example, the gaming operating system 230 inspects a layer (e.g., physical layer, data link layer, network layer, etc.) of the gaming network communication packet. The flow continues at block 406.

At block 406, a determination is made about whether there are firewall rules for this layer. For example, the gaming device firewall 232 determines whether any of the firewall rules 238 govern the protocol layer under inspection. The firewall rules 238 can include rules governing some or all protocol stack layers. If there are firewall rules for the current layer, the flow continues at block 408. Otherwise, the flow continues at block 414.

At block 408, firewall rules are applied to the gaming network communication packet. For example, the gaming device firewall 232 applies the firewall rules 238 to the gaming network communication packet. In one embodiment, the firewall rules 238 help the gaming device firewall 232 to make decisions based on a packet's structure, protocol type (e.g., TCP, UDP, etc.), and/or destination port or address (EP, MAC, etc.). In another embodiment, the gaming device firewall 232 can use the firewall rules 238 for determining how to proceed after finding protocol errors or after determining a packet was received from a particular network (e.g., the secure gaming network 204 or the unsecured gaming network 236). In yet another embodiment, the firewall rules indicate how to proceed when certain thresholds have been met or exceeded (e.g., number of TCP connect requests within a certain time period). The flow continues at block 410.

At block 410, a determination is made, based on the firewall rules, whether the gaming network communication packet should be dropped. For example, the gaming device firewall 232 uses the firewall rules 238 for determining whether the gaming network communication packet should be dropped. In one embodiment, the firewall rules 238 drop gaming network communication packets that are malformed, from forbidden source addresses, exceed certain thresholds, etc. If the gaming network communication packet should be dropped, the flow continues at block 412. Otherwise, the flow continues at block 414.

At block 412, the gaming network communication packet is dropped. For example, the gaming operating system 230 drops the gaming network communication packet. In one embodiment, the gaming operating system 230 records a log entry indicating that the gaming network communication packet was dropped. In one embodiment, gaming machine components do not perform any further processing of dropped gaming network communication packets. From block 412, the flow ends.

A block 414, a determination is made about whether there are more layers to inspect. For example, the gaming operating system 230 determines whether it should inspect additional network protocol layers of the gaming network communication packet. If there are more layers to inspect, the flow continues at block 416. Otherwise, the flow continues at block 418.

At block 416, the next layer is found. For example, the gaming operating system 230 finds the next layer of the gaming network communication packet. From block 416, the flow continues at block 404.

At block 418, a determination is made about whether the gaming network communication packet is a control packet. For example, gaming operating system 230 determines whether the gaming network communication packet is a control packet. If the gaming network communication packet is a control packet, the flow continues at block 420. Otherwise, the flow continues at block 422.

At block 420, the control packet is processed. For example, the gaming operating system 230 processes the control packet according to the current network protocol layer. From block 420, the flow ends.

A block 422, the gaming network communication packet is delivered to an appropriate application. For example, the gaming operating system 230 delivers the gaming network communication packet to a gaming application. In one embodiment, the gaming operating system 230 inserts the gaming network communication packet in a socket queue associated with the gaming application. In one embodiment, the gaming operating system 230 is unaware of applications, so it sends the gaming network communication packet to a particular port. In one embodiment, the gaming operating system 230 delivers the gaming network communication packet to an application or port based on logic in the firewall rules 238. From block 422, the flow ends.

This description will continue with a discussion of operations for filtering network traffic received through multiple network interfaces. According to some embodiments, gaming machines that include a plurality of gaming network interfaces (see FIG. 2) can drop or further filter traffic received through certain network interfaces.

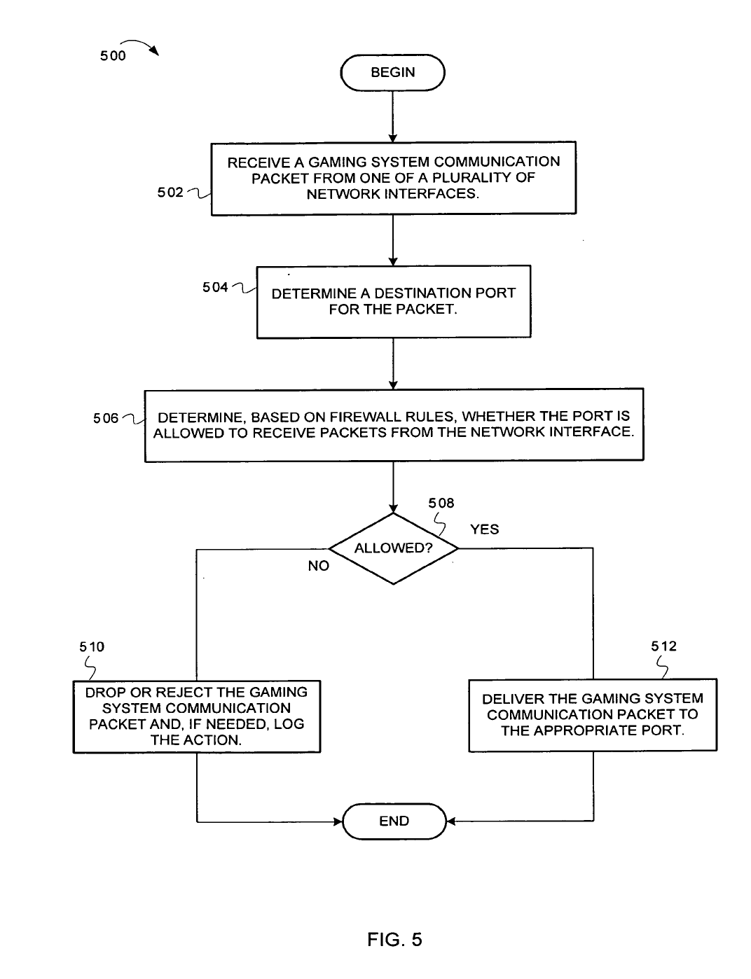

FIG. 5 is a flow diagram illustrating operations for filtering network traffic through network interfaces on a gaming machine, according to example embodiments of the invention. The flow diagram 500 commences at block 502.

At block 502, a gaming network communication packet is received through one of a plurality of network interfaces of a gaming machine. For example, gaming operating system 230 receives a gaming network communication packet though the network interface unit 234. The flow continues at block 504.

At block 504 the packet's destination port is determined. For example, the gaming operating system 230 determines a port (not shown) for which the gaming network communication packet is destined. In one embodiment, the port can be associated with a gaming machine configuration application, software downloading application, community game application, etc. The flow continues at block 506.

At block 506, a determination is made, based on firewall rules, whether the port is allowed to receive packets from the network interface. For example, gaming device firewall 232 determines whether the firewall rules 238 allow the destination port to receive packets from the network interface unit 234. In one embodiment, the firewall rules 238 do not allow ports to receive packets through network interface units connected to unsecured gaming networks. However, in one embodiment, an operator can disable the gaming device's firewall rules by entering authentication information, such as a password or biometric information. The flow continues at block 508.

At block 508, if the port is allowed to receive packets from the network interface, the flow continues at block 512. Otherwise, the flow continues at block 510.

At block 510, the gaming network communication packet is dropped. For example gaming operating system 230 drops the gaming network communication packet. In one embodiment, gaming operating system 230 logs that the gaming network communication packet was dropped. From block 510, the flow ends.

At block 512, the gaming network communication packet is delivered to the destination port. In one embodiment, instead of immediately delivering the packet, the gaming device firewall 232 applies additional firewall rules (e.g., rules for a different protocol layer) to the packet. The additional rules may cause the gaming operating system 230 to drop the packet before delivering it to the destination port. From block 512, the flow ends.

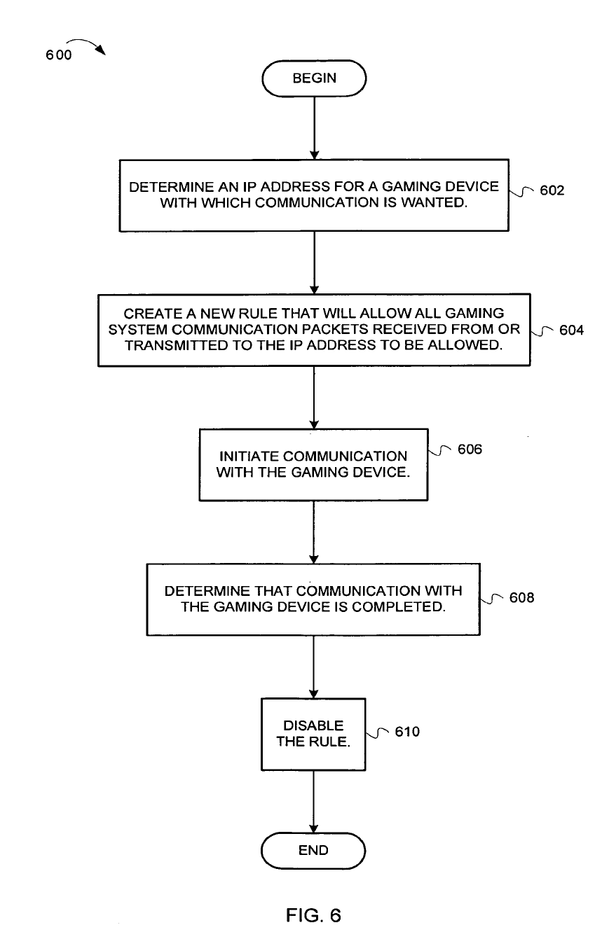

While FIGS. 4 and 5 describe embodiments that apply firewall rules for filtering network traffic, FIG. 6 describes embodiments that can dynamically modify the firewall rules. Dynamically modifying firewall rules enables gaming machines to temporarily allow network traffic from a particular source, while later blocking (i.e., dropping) traffic from that source. As a result, a gaming machine can dynamically modify firewall rules to allow it to receive gaming content from a gaming content server. This description continues with FIG. 6.

FIG. 6 is a flow diagram illustrating operations for dynamically modifying and applying firewall rules, according to example embodiments of the invention. The flow diagram 600 commences at block 602.

At block 602, a gaming device's network address is determined. For example gaming operating system 230 determines an IP address for a gaming device in a gaming network. In one embodiment, the gaming operating systems 230 looks-up the IP address in a local table or it can determine the IP address using a Domain Name System (DNS). In one embodiment, the gaming machine 206 will use the network address to communicate with a download server or a central determination server. The flow continues at block 604.

At block 604, a new rule is created, where the new rule allows exchange of gaming network communication packets with the network address. For example, the gaming device firewall 232 creates a new firewall rule 238 allowing transmission/receipt of gaming network communication packets to/from the IP address. The flow continues at block 606.

At block 606, communications with the gaming device are initiated. For example, the gaming operating system 230 requests gaming content from the gaming device located at the IP address. In one embodiment, the flow ends at block 606. In another embodiment, the flow continues at block 608.

At block 608, it is determined that communications with the gaming device are complete. For example, the gaming operating system 230 determines that it has received the requested gaming content. In one embodiment, the gaming operating system 230 informs the gaming device firewall 232 that the gaming content download is complete. The flow continues at block 610.

At block 610, the rule is deleted. For example, the gaming device firewall 232 deletes the firewall rule that it created at block 604; thus, no longer allowing exchange of gaming network packets from the network address. In one embodiment, the gaming device firewall 232 deletes a dynamically created firewall rule based on feedback from the gaming operating system 230. In one embodiment, the gaming operating system 230 deletes the rule from the firewall rules 238. From block 610, the flow ends.

Although the flow 600 describes dynamically modifying firewall rules for purposes of exchanging communications with a particular network address, other embodiments call for modifying the firewall rules 238 for other reasons. For example, a gaming machine can modify the firewall rules to relax thresholds, allow previously unapproved protocol types, allow malformed packets/frames, etc.

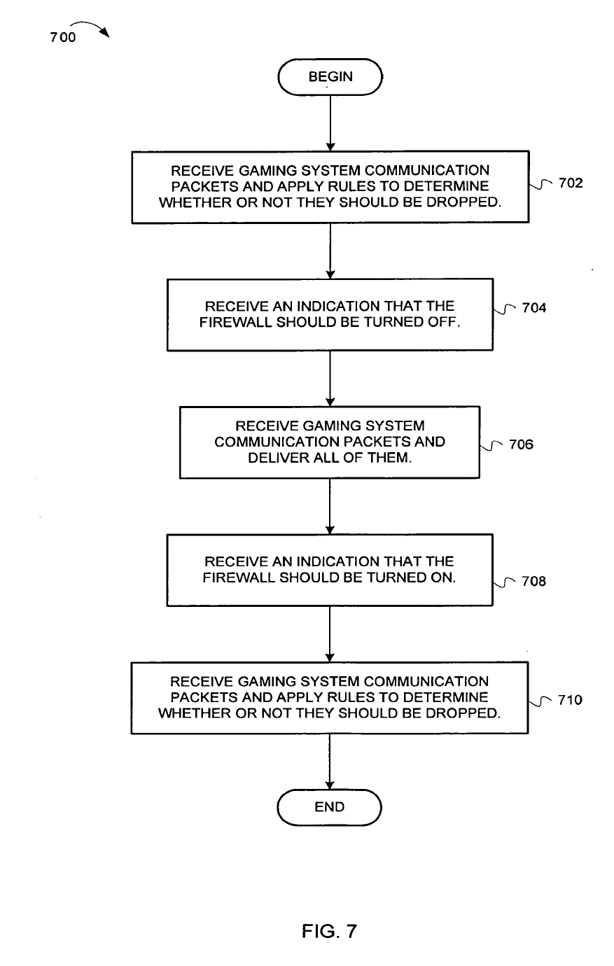

This description continues with a discussion of embodiments of the gaming device firewall that can be dynamically switched on and off. In one embodiment, when the gaming device firewall is switched off, it does not filter network traffic. Gaming operators may want to switch-off the firewall when remotely configuring/maintaining gaming machines. When the firewall is switched-off, gaming operators need not worry about the firewall dropping traffic containing necessary configuration/maintenance information. FIG. 7 describes this in greater detail.

FIG. 7 is a flow diagram illustrating operations for dynamically switching the firewall on/off, according to example embodiments of the invention. The flow diagram 700 commences at block 702.

At block 702, gaming network communication packets are received and rules are applied to determine whether the gaming network communication packets should be dropped. For example, operating system 230 receives gaming network communication packets and applies the firewall rules 238 to determine whether the gaming system to the data packets should be dropped (for more details see FIG. 4). The flow continues at block 704.

At block 704, an indication that the firewall should be switched-off is received. For example, the gaming operating system 230 receives an indication that the gaming device firewall 232 should be switched-off. In one embodiment, the indication is received as a result of an administrator entering a command and/or password in a graphical user interface (e.g., a web browser). After the gaming device firewall 232 is switched off, the administrator can remotely configure and/or maintain the gaming device 206 over the unsecured network 236. The flow continues at block 706.

At block 706, gaming network communication packets are received and delivered. For example, the gaming operating system 230 receives and delivers all gaming network communication packets without dropping any of the packets. The flow continues at block 708.

At block 708, an indication that the firewall should be switched-on is received. For example, operating system 230 receives an indication that the gaming device firewall 232 should be switched-on. In one embodiment, the indication is received as a result of an administrator command. The flow continues at block 710.

At block 710, gaming network communication packets are received and rules are applied to determine whether the gaming network communication packets should be dropped. For example, the gaming operating system 230 receives gaming network communication packets and the gaming device firewall 232 applies the firewall rules 238 to determine whether the gaming network communication packets should be dropped. From block 710, the flow ends.

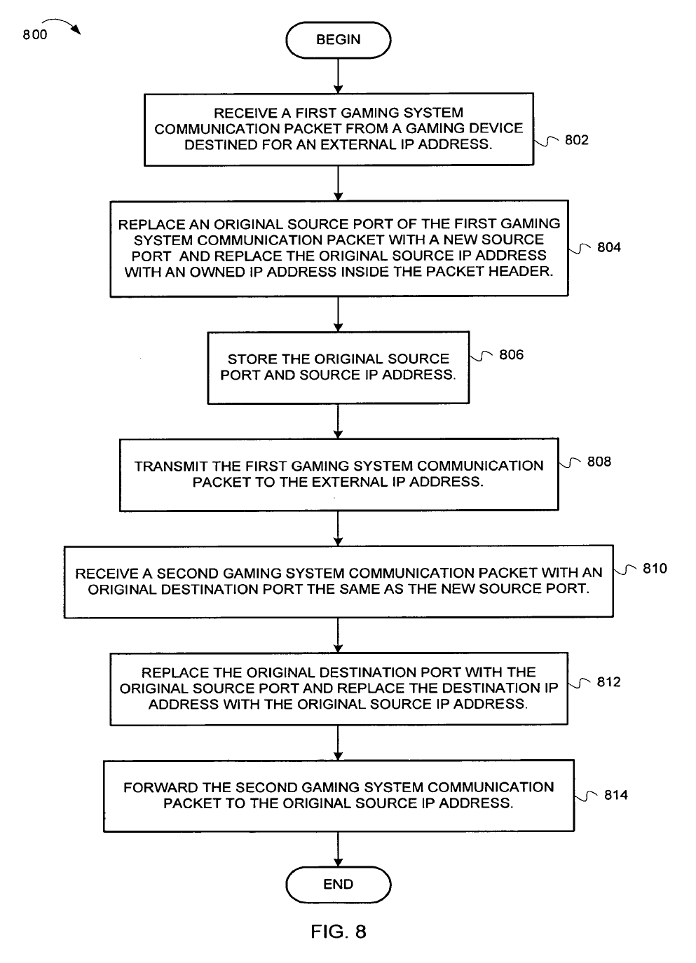

While FIG. 7 describes how embodiments of the firewall can dynamically switch on and off, FIG. 8 describes how embodiments of the firewall can provide IP masquerading and Network Address Translation (NAT) services. As noted above (see discussion of FIG. 2), gaming machines can include IP-aware peripheral devices that can communicate with devices (e.g., maintenance servers) on a gaming network. For example, IP-aware peripherals can download firmware updates and other configuration information over gaming networks. Embodiments of the gaming device firewall facilitate these communications by providing NAT and IP masquerading services. The discussion of FIG. 8 describes this in more detail.

FIG. 8 is a flow diagram illustrating operations for performing IP masquerading and Network Address Translation, according to example embodiments of the invention. The flow diagram 800 commences at block 802.

At block 802, a first gaming network communication packet is received from a peripheral device, where the gaming network communication packet is destined for an IP address external to a gaming device. For example, a gaming machine's gaming device firewall 232 receives a first gaming network communication packet from an IP-aware payout mechanism 208 or other IP-aware peripheral device. The first gaming network communication packet can be destined for a maintenance server (not shown) on the secure gaming network 204. The flow continues at block 804.

At block 804, an original source port of the first gaming network communication packet is replaced with a new source port and the original source IP address is replaced with an IP address assigned to the gaming device. For example, the gaming device firewall 232 replaces the first gaming network communication packet's original source port with a new source port and it replaces the packet's original source IP address with the gaming device's IP address. Alternatively, in one embodiment, the original source port is not replaced. Instead, only the original source IP address is replaced with the gaming device's IP address. The flow 800 continues at block 806.

At block 806, the original source port and original source IP address are stored. For example gaming device firewall 232 stores the original source port and the source IP address. The flow continues at block 808.

At block 808, the first gaming system packet is transmitted to the external IP address. For example, the gaming device firewall 232 transmits the first gaming system packet to a maintenance server (not shown) located on the secure network 204 at the external IP address. The flow continues at block 810.

At block 810, a second gaming system packet is received, where the packet's original destination port is the same as the new source port (see block 804). For example, the gaming device firewall 232 receives a second gaming system packet whose original destination port is the same as the new source port. The flow continues at block 812.

At block 812, the original destination port is replaced with the original source port and the destination IP address is replaced with the original source IP address. For example, the gaming device firewall 232 replaces the original destination port with the original source port and it replaces the destination IP address with the original source IP address. The flow continues at block 814.

At block 814, the second gaming system packet is forwarded to the original source IP address. For example, gaming device firewall 232 forwards the second gaming system packet to the IP address of the IP-aware payout mechanism 208. From block 814, the flow ends.

The next section describes additional embodiments of the invention.

### Example Gaming Machine

FIG. 9 is a perspective view of a gaming machine, according to example embodiments of the invention. As shown in FIG. 9, the gaming machine 900 can be a computerized slot machine having the controls, displays, and features of a conventional slot machine.

The gaming machine 900 can be mounted on a stand 942 or it can be constructed as a pub-style tabletop game (not shown). As a result, the gaming machine 900 can be operated while players are standing or seated. Furthermore, the gaming machine 900 can be constructed with varying cabinet and display designs. The gaming machine 900 can incorporate any primary game such as slots, poker, or keno, and additional bonus round games. The symbols and indicia used on and in the gaming machine 900 can take mechanical, electrical, or video form.

As illustrated in FIG. 9, the gaming machine 900 includes a coin slot 902 and bill acceptor 924. Players can place coins in the coin slot 902 and paper money or ticket vouchers in the bill acceptor 924. Other devices can be used for accepting payment. For example, credit/debit card readers/validators can be used for accepting payment. Additionally, the gaming machine 900 can perform electronic funds transfers and financial transfers to procure monies from financial accounts. When a player inserts money in the gaming machine 900, a number of credits corresponding to the amount deposited are shown in a credit display 906. After depositing the appropriate amount of money, a player can begin playing the game by pushing play button 908. The play button 908 can be any play activator used for starting a wagering game or sequence of events in the gaming machine 900.

As shown in FIG. 9, the gaming machine 900 also includes a bet display 912 and one or more “bet” buttons on the panel 916. The player can place a bet by pushing one or more of the bet buttons on the panel 916. The player can increase the bet by one or more credits each time the player pushes a bet button. When the player pushes a “bet one” button 916, the number of credits shown in the credit display 906 decreases by one credit, while the number of credits shown in the bet display 912 increases by one credit.

A player may end the gaming session or “cash-out” by pressing a cash-out button 918. When a player cashes-out, the gaming machine 900 dispenses a voucher or currency corresponding to the number of remaining credits. The gaming machine 900 may employ other payout mechanisms such as credit slips (which are redeemable by a cashier) or electronically recordable cards (which track player credits), or electronic funds transfer.

The gaming machine also includes a primary display unit 904 and a secondary display unit 910 (also known as a “top box”). The gaming machine may also include an auxiliary video display 940. In one embodiment, the primary display unit 904 displays a plurality of video reels 920. According to embodiments of the invention, the display units 904 and 910 can include any visual representation or exhibition, including moving physical objects (e.g., mechanical reels and wheels), dynamic lighting, and video images. In one embodiment, each reel 920 includes a plurality of symbols such as bells, hearts, fruits, numbers, letters, bars or other images, which correspond to a theme associated with the gaming machine 900. Additionally, the gaming machine 900 also includes an audio presentation unit 928. The audio presentation unit 928 can include audio speakers or other suitable sound projection devices.

In one embodiment, the gaming machine 900 can include a gaming device firewall for filtering gaming network communications, as further described herein.

### General

In this description, numerous specific details are set forth. However, it is understood that embodiments of the invention may be practiced without these specific details. In other instances, well-known circuits, structures and techniques have not been shown in detail in order not to obscure the understanding of this description. Note that in this description, references to “one embodiment” or “an embodiment” mean that the feature being referred to is included in at least one embodiment of the invention. Further, separate references to “one embodiment” in this description do not necessarily refer to the same embodiment; however, neither are such embodiments mutually exclusive, unless so stated and except as will be readily apparent to those of ordinary skill in the art. Thus, the present invention can include any variety of combinations and/or integrations of the embodiments described herein. Each claim, as may be amended, constitutes an embodiment of the invention, incorporated by reference into the detailed description.

Herein, block diagrams illustrate example embodiments of the invention. Also herein, flow diagrams illustrate operations of the example embodiments of the invention. The operations of the flow diagrams are described with reference to the example embodiments shown in the block diagrams. However, it should be understood that the operations of the flow diagrams could be performed by embodiments of the invention other than those discussed with reference to the block diagrams, and embodiments discussed with references to the block diagrams could perform operations different than those discussed with reference to the flow diagrams. Additionally, some embodiments may not perform all the operations shown in a flow diagram. Moreover, although the flow diagrams depict serial operations, certain embodiments could perform certain of those operations in parallel.

1. A gaming device comprising:
a network interface card operable to receive a plurality of gaming network communication packets from a gaming network;
a gaming device firewall coupled to the network interface card to receive the plurality of gaming network communication packets, and operable to apply a set of firewall rules to the plurality of gaming network communication packets and to drop some of the gaming network communication packets based on the set of firewall rules; and
a set of gaming device applications operable to receive at least some undropped ones of the gaming network communication packets from the gaming device firewall.

2. (canceled)

3. The gaming device of claim 1, wherein the gaming device firewall can be disabled through a user interface.

4. The gaming device of claim 1, wherein the gaming device firewall can be disabled by entering a user authentication information through a user interface.

5. The gaming device of claim 1 further comprising:
a set of Internet Protocol-aware peripheral devices, wherein the gaming device firewall is further operable to perform network address translation on certain of the plurality of gaming network communication packets.

6. The gaming device of claim 1, wherein the gaming device firewall can dynamically modify the firewall rules as a result of receiving input through a user interface.

7. A computer-implemented method comprising:
receiving, in a gaming device, a gaming network communication packet from a gaming network at a network interface unit included in the gaming device;
performing firewall operations on the gaming network communication packet after receiving the gaming network communication packet at a firewall, the firewall operations including,
determining, based on firewall rules, whether the gaming network communication packet should be dropped; and
if the gaming network communication packet should be dropped, dropping the gaming system communication packet; and
if the gaming network communication packet should not be dropped, delivering the gaming system communication packet to a port of the gaming device.

8. The computer-implemented method of claim 7, wherein the determining includes inspecting protocol layers of the gaming network communication packet.

9. The computer-implemented method of claim of claim 8, wherein the protocol layers include Transmission Control Protocol Layer and an Internet Protocol layer.

10. The computer-implemented method of claim 7, wherein the determining further includes:
inspecting one of a plurality of protocol layers of the gaming network communication packet; and
if there is not a firewall rule for one of the plurality of protocol layers, inspecting another of the protocol layers.

11. The computer-implemented method of claim 7, further comprising dropping the gaming system communication packet for reasons other than the firewall rules.

12. The computer-implemented method of claim 7, wherein the port of the gaming device is associated with an application for which the gaming system communication packet is destined.

13. The computer-implemented method of claim 7, wherein the gaming device includes a secure network connection and an unsecured network connection.

14. A machine-readable medium comprising instructions which when executed cause a machine to perform operations comprising:
receiving a gaming system communication packet from one of a plurality of network interfaces comprising network interface units of a gaming device;
determining a destination port for the gaming system communication packet;
determining, after the receiving, and based on ones of a set of firewall rules, whether the destination port is allowed to receive packets from the one of the plurality of network interfaces; and
if the destination port is allowed to receive packets from the one of a plurality of network interfaces, delivering the gaming system communication packet to the destination port.

15. The machine-readable medium of claim 14, wherein the plurality of network interfaces includes a first network interface unit associated with an unsecured network and a second network interface unit associated with a secure network.

16. The machine-readable medium of claim 14, wherein the determining whether the destination port is allowed to receive packets from the one of the plurality of network interfaces is based on whether the destination port is associated with a secure network or an unsecured network.

17. The machine-readable medium of claim 14, wherein the destination port is associated with a gaming device application selected from the group consisting of device configuration applications, software downloading applications, and wide-area progressive applications.

18. The machine-readable medium of claim 14, the operations further comprising:
if the port is not allowed to receive packets from the one of the plurality of network interfaces, dropping the gaming system communication packet.

19. The machine-readable medium of claim 14, the operations further comprising:
if the port is not allowed to receive packets from the one of the plurality of network interfaces,
requesting user authentication data;
receiving the user authentication data; and
delivering the gaming system communication packet to the destination port.

20. The machine-readable medium of claim 14, wherein the gaming system communication packet is a data packet or a control packet.
